(19) United States
(12) Patent Application Publication
(10) Pub. No.: US 2013/0241110 A1
(43) Pub. Date: Sep. 19, 2013

(54) THERMOFORMED PLASTIC LABORATORY BEAKER CONFIGURED TO STABILIZE TEMPERATURE AND RESIST TIPPING

(71) Applicant: Daniel Perlman, Arlington, MA (US)

(72) Inventor: Daniel Perlman, Arlington, MA (US)

(21) Appl. No.: 13/606,049

(22) Filed: Sep. 7, 2012

Related U.S. Application Data
(62) Division of application No. 12/917,610, filed on Nov. 2, 2010, now abandoned.

(51) Int. Cl. B01L 3/00

(52) U.S. Cl. CPC B01L 3/00
USPC 264/322

(57) ABSTRACT

A thermoplastic laboratory beaker that holds liquid in a reservoir portion of the beaker, in which the beaker includes a first upright, generally circular, outer sidewall and a second inner sidewall which are united at their upper limit height to form a lip edge or lip surface. The two sidewalls typically diverge from each other below the lip surface to create an air space between them. The outer sidewall extends downward a first distance D1 below the lip surface, and then usually bends outward to form a substantially planar supporting flange that at least partially supports the weight of said beaker on a laboratory surface. The inner sidewall extends downward a second distance D2 from the lip surface, and then bends inward to form a bottom wall for the reservoir portion that intersects the central vertical axis of said beaker, in which the inner sidewall and the bottom wall form the reservoir portion for holding a liquid.

### RELATED APPLICATIONS

NOT APPLICABLE.

### FIELD OF THE INVENTION

The present invention relates to the structure and fabrication of thermoplastic laboratory beakers.

### BACKGROUND OF THE INVENTION

The following discussion is provided solely to assist the understanding of the reader, and does not constitute an admission that any of the information discussed or references cited constitute prior art to the present invention.

Laboratory containers whose wall materials and shapes have been selected and adapted for specialized uses are described in numerous patents. For example, specialized cell culture flasks have been modified extensively in recent years to improve gas exchange, growth of cells and facilitate cell harvesting. On the other hand, general purpose laboratory containers including, for example, beakers, bottles, flasks, graduated cylinders, and Petri dishes are designed to hold a wide variety of liquids in the laboratory. These containers are currently fabricated from a variety of thermoplastic resins as well as glass. Each material has characteristic physical properties and/or chemical resistances. Laboratory liquid storage containers may be used for the storage of aqueous buffers, acids and alkalis, organic solvents, reagents, enzyme solutions, nutrient media and the like. Such containers are described in many different scientific catalogs [see pages 146-152 in the Fisher Scientific Catalog 2008-2009 Edition (Pittsburgh, Pa.) for examples].

The laboratory beaker, which for many decades was fabricated exclusively from glass or metal, is now available in a variety of thermoplastic resins including polyethylene, polypropylene, polycarbonate and polymethypentene. For a number of years, thermoplastic beakers have been commercially produced in sizes ranging from approximately 10 cc to at least 5 liters. The typical laboratory beaker has a characteristic shape (cylindrical or slightly tapered cylindrical form) and a flat-bottom that can rest on a flat surface such as a laboratory bench, incubator shelf or a heating platform. The upper edge of the beaker's sidewall often includes a circumferential lip or flange with a small groove/spout to facilitate the pouring of liquids. The essential shape of the beaker has not varied significantly over recent years.

### SUMMARY OF THE INVENTION

The present invention concerns a new development in laboratory beakers. Current conventional beakers are single-walled containers typically formed of glass or plastic in a generally cylindrical form with a curved portion forming the transition from sidewall to bottom of the beaker. In contrast, the present beakers are double-walled containers configured to provide both greater stability and greater thermal insulation than conventional beakers. Beneficially, these beakers can be configured in a manner such that they can be constructed by thermoforming from thermoplastic sheets.

Thus, in a first aspect the invention provides a thermoplastic laboratory beaker that holds liquid in a reservoir portion of said beaker. The beaker includes an outer upright sidewall, an inner sidewall, and a bottom wall which together form an open-topped container (usually the inner and outer walls are concentric or substantially concentric) and a bottom wall which together form an open-topped container. The outer sidewall and inner sidewall are united at their upper limit (usually continuously) forming a lip surface and diverge from each other below that lip surface creating an air space between the sidewalls. The outer sidewall extends downward a first distance D1 below the lip surface to a support contact area formed at the lower limit of the outer sidewall. The inner sidewall extends downward a second distance D2 from the lip surface and bends inward (commonly through a curved transition zone) joining with the bottom wall, together forming the reservoir portion. Highly preferably D2 is equal to or less than D1.

In certain embodiments, the reservoir portion has a central vertical axis which is substantially the same as the central vertical axis of the outer sidewall; the inner sidewall and/or the outer sidewall are substantially circular in horizontal cross-section; the beaker has a liquid capacity of 10 ml to 5 L, 10 ml to 1 L, 10 ml to 300 ml, 50 ml to 5 L, 50 ml to 1 L, 50 ml to 300 ml, 250 ml to 5 L, 250 ml to 1 L, or 1 L to 5 L; the radius of curvature transitioning from the inner sidewall to the bottom wall is at least 7%, 10%, 15%, or 20% of the height of the inner sidewall or is in a range of about 7 to 15% or 10-20% or 12-25%; the radius of curvature of the transition zone from inner sidewall to bottom wall is about 0.64 cm, about 0.0.83 cm, about 1.25 cm, about 1.90 cm, or about 2.54 cm; the radius of curvature of the transition zone is about 10, 15, 20, 25, 30, 40, 50, 60, 80, or 100% of the radius of the reservoir measured immediately above the transition zone or is in a range of 10 to 30%, 20 to 50%, 40 to 60%, or 60 to 100% of that radius.

In particular embodiments, the bottom wall is curved upward; the bottom wall is curved upward (i.e., upward concave) with a radius of curvature which is at least 1.2, 1.4, 1.7, 2.0, 3.0, 4.0, 5.0, or 10.0 times the radius of the reservoir measured immediately below the lip surface; the inner sidewall includes a conical section which diverges from the outer sidewall by at least 20, 30, 40, 50, 60, or 70 degrees, or diverges from the outer sidewall in a range of 20 to 40 degrees, 30 to 50 degrees, or 40 to 70 degrees.

In advantageous embodiments, the support contact area of the outer sidewall curves outward forming a surface contact flange; the surface contact flange has a width in a range of 1 mm to 2 cm, 1 mm to 1 cm, 1 mm to 5 mm, or 1 cm to 2 cm measured along the radius of the beaker; the flange is substantially planar (this, for example, allows the beaker to rest flat and remain stable on a horizontal planar support surface without liquid rocking or splashing out of the beaker during liquid transfer operations).

In particular embodiments, the beaker is fabricated from a thermoplastic resin sheet material using thermoform processing; the beaker is fabricated from a thermoplastic resin material, e.g., selected from polyester, PET, polyethylene and polypropylene sheet; the beaker is fabricated from thermoplastic sheet material with a thickness of 0.020 in. to 0.060 in, 0.020 in to 0.040 in, 0.025 in to 0.040 in, 0.025 in to 0.035 in, 0.030 to 0.060 in, 0.30 to 0.40 in, or 0.040 to 0.060 in; the inner and outer sidewalls are transparent or at least substantially transparent.

In beneficial embodiments, the first distance D1 is greater than the second distance D2, whereby the support contact area rests on a support surface while the bottom wall remains elevated above the support surface; D1 is greater than D2 by 1 mm to 20 mm, 1 mm to 15 mm, 1 mm to 10 mm, 1 mm to 5 mm, 2 mm to 10 mm, or 2 mm to 7 mm, or is about 1, 2, 3, 4, 5, 6, 7, 8, 9, or 10 mm.

Also in beneficial embodiments, the aspect ratio of the reservoir portion (i.e., the ratio of reservoir depth to reservoir opening diameter) is at least 1.05, 1.10, 1.15, or 1.20, is about 1.2 or about 1.3, or is in a range of 1.05 to 1.3, 1.05 to 1.25, 1.10 to 1.30, 1.10 to 1.25, 1.10 to 1.3, or 1.15 to 1.25.

In certain embodiments, the support contact area and the bottom wall are substantially perpendicular to the central vertical axis of the reservoir portion and are substantially horizontal when the beaker rests on the support contact area on a level planar support surface.

Also in advantageous embodiments, the beaker also includes at least one groove (usually U or V-shaped groove) that traverses the lip surface and facilitates the pouring of liquid from the reservoir portion; the beaker includes at least two U or V-shaped grooves that are aligned opposite one another on the lip surface and traverse the lip surface (that is, at least one pair or grooves on opposing sides of the beaker, allowing a liquid dispensing pipette to be rested horizontally and stably on two of the grooves (e.g., two opposing grooves); the lip surface includes at least one ventilation opening; the inner sidewall includes volumetric graduation markings (usually on the inner surface of the inner sidewall).

In further advantageous embodiments, the beaker is configured to allow compact nesting of a plurality of the beakers of equal liquid capacity, e.g., with each successive nested beaker after the first adding to the overall length of the nested beakers no more than 0.5, 0.3, 0.2, or 0.1 times the height of each individual beaker.

A related aspect of the invention provides a method for making a double-walled beaker, where the method involves thermoforming a heated thermoplastic sheet on a thermoform mold configured such that the sheet is formed into an open-topped beaker which includes an outer upright sidewall, an inner sidewall, and a bottom wall which together form an open-topped container. The outer sidewall and inner sidewall are united at their upper limits forming a lip surface and diverge from each other below the lip surface creating an air space between the sidewalls. The outer sidewall extends downward a first distance D1 below the lip surface to a support contact area formed at the lower limit of the outer sidewall and the inner sidewall extends downward a second distance D2 from the lip surface and then bends inward joining with a bottom wall, together forming a reservoir portion. Typically, D2 is equal to or less than D1.

In particular embodiments, the resulting beaker is as specified for the first aspect above or otherwise described herein for the present invention.

Another related aspect concerns a method for reducing the rate of equilibration of a liquid in a beaker to the temperature of the medium external to the beaker (i.e., reducing heat flow) by placing a liquid at a temperature significantly different from the external medium temperature in a beaker as specified in the first aspect above or otherwise described herein for the present invention. The reduction in rate is shown in comparison to the rate for the same liquid in a conventional borosilicate glass beaker of essentially the same liquid capacity (typically within 10% of the same liquid capacity).

In particular embodiments, the liquid is at a temperature which is at least 10, 15, 20, 25, 30, 40, or 50 degrees C. different from the external medium temperature (e.g., ambient air temperature); the liquid is held in the beaker for a period of at least 1, 2, 3, 5, 10, 20, 30, 40, or 60 minutes.

Additional embodiments will be apparent from the Detailed Description, the Drawings, and the claims.

### BRIEF DESCRIPTION OF THE DRAWINGS

FIG. 1 is a side view of a typical thermoformed plastic beaker (100 ml size) of the present invention with the central axis of the beaker oriented vertically.

FIG. 2 is a side view of a typical thermoformed plastic beaker (250 ml size) of the present invention with the central axis of the beaker oriented vertically.

FIG. 3 is a perspective side view of the beaker shown in FIG. 2.

### DETAILED DESCRIPTION OF THE PREFERRED EMBODIMENTS

The present invention relates to the structural configuration, fabrication, and use (most often laboratory use) of a cost-effective thermoplastic laboratory beaker that is preferably thermoformed from a sheet of plastic, e.g., 20-60 mil thick (0.020-0.060 in), for example, polyester, polyethylene terephthalate (PET or PETE), polyethylene, or polypropylene. The beaker is fabricated to include a double sidewall structure with an air gap between the two walls. The double sidewall structure and air gap between the walls provide at least two significant benefits:
(a) Thermal insulation for a liquid or other material held in the beaker
(b) Larger footprint providing greater beaker stability against accidental tipping

Advantageously, the beaker is formed by thermoform molding. One of the advantages of using thermoform molding is cost. Comparison of the cost to produce a thermoplastic resin beaker of the present configuration using thermoforming rather than injection molding shows that the former method is considerably less expensive than the latter.

In this double-wall beaker, the two walls include an outer sidewall and an inner sidewall that are connected (typically seamlessly connected, i.e., physically continuous, at the lip of the beaker) where the walls meet and form the lip edge or lip surface. In embodiments in which the reservoir is similar in shape to traditional beakers, the inner sidewall extends more or less vertically downward from the lip of the beaker, and together with the bottom wall portion of the beaker, form and define the liquid-holding reservoir of the beaker. More specifically, the lowermost portion of the inner sidewall is thermoformed and bent horizontally inward to form the bottom wall portion of the beaker.

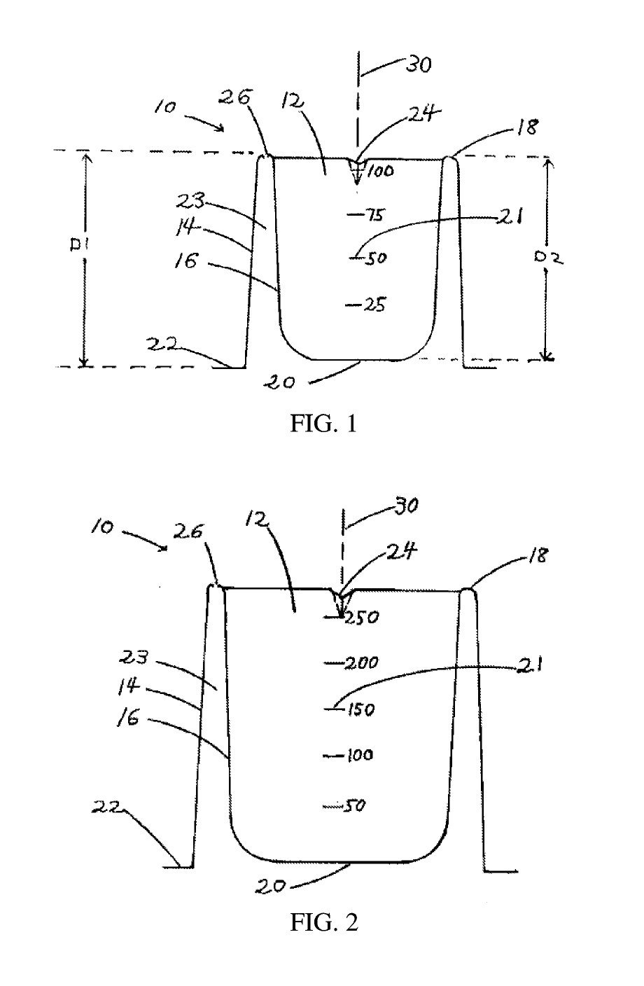

Viewed in vertical cross-section, the beaker profile resembles the letter M in which the M's central valley is thermoformed and stretched into a somewhat U-shaped reservoir for holding liquid. The bottom of the U-shaped portion can be formed in a variety of shapes, e.g., flat, curved with a radius of curvature greater than the radius of the reservoir Thus, in summary, the U-shaped reservoir portion of the beaker is defined by the inner sidewall and the bottom wall of the beaker. The outer sidewall of the beaker corresponds to the outer upright elements of the letter M. To add physical rigidity and stabilize the beaker against accidental tipping and spilling of liquids, the lower edge of the outer sidewall of the beaker is preferably bent outward around the beaker, i.e., thermoformed generally horizontally outward, to form a substantially flat or planar supporting flange (also referred to as “supporting foot” or “supporting ring” or simply “flange”) around the circumference of the beaker as shown in FIGS. 1, 2 and 3.

The location of the outward bend in the beaker's outer sidewall (producing the supporting flange) is preferably set such that the bottom surface of the resulting flange is slightly below (e.g., 1-10 mm below) the bottom wall of the beaker so that the beaker will rest on the supporting flange rather than on the beaker's bottom wall when placed on a flat surface. Therefore, when the beaker rests on a flat laboratory surface, a beneficial thermally insulating airspace is created outside the beaker's inner sidewall and also beneath the beaker's bottom wall that together define the liquid-holding reservoir of the beaker. When compared with a conventional single-walled beaker that is susceptible to changing external temperature, this airspace helps maintain a more constant temperature (i.e., slows heat flow), if so desired, when either a hot or cold liquid is placed in the presently configured beaker. Similarly, when manually holding or carrying a beaker, the double wall insulated design of the beaker helps prevent ones hand from altering the temperature of the liquid in the beaker (and helps prevent hand injury from a very cold or hot liquid in the beaker).

Though inclusion of the flange is advantageous, the beakers can be constructed without the flange. That is, the beakers are designed to rest flat upon a support surface, either on the planar thermoformed supporting flange of the beaker (the flange being horizontally oriented) or, in the absence of a supporting flange, resting on the lowermost edge of the outer sidewall of the beaker. For thermoformed beakers, the lower edge may need to be subjected to a post-molding process (e.g., cutting) to create an even edge so that the beaker will rest stably on the support surface. In either instance, as indicated above the bottom wall (flat or other shape as described) of the liquid holding reservoir portion of the beaker is preferably thermoformed and positioned a small distance (e.g., 1-10 mm) above the plane surface upon which the beaker rests.

In addition to the flange, other portions of the beaker can advantageously be configured for use and/or construction advantages. Thus, the double-walled beakers are advantageously configured with an aspect ratio (can also be referred to as “form factor”) of greater than one. That is the depth of the reservoir is greater than the reservoir diameter at the top of the straight portion of the inner sidewall. Making containers with aspect ratios greater than one, and especially substantially greater than one, is difficult by thermoforming, but has been accomplished for these containers. Such aspect ratios are advantageous for beakers because the taller shape makes volumetric graduation markings for reading the liquid meniscus position further separated and therefore more easily readable. The taller shape also reduces the area of the liquid's upper surface and therefore reduces the residual liquid volume or volume lost in the bottom of the reservoir, and also reduces evaporative losses from the liquid's upper surface. In advantageous cases, the aspect ratio is about 1.05, 1.10, 1.1.5, 1.20, 1.25, 1.30, or even greater.

In this regard, it has been found beneficial to have a relatively large radius of curvature for the transition zone between the often straight inner sidewall and the bottom wall, particularly when using thermoform processing. In this process, as the beaker is molded, the portion of the thermoplastic sheet that will form the bottom wall of the beaker can contribute and feed material around the transition zone curve to reduce inner sidewall thinning. In many cases, the radius of curvature in that transition zone will be from about 0.5 cm to 3 cm, and may depend on the height of the inner sidewall and the volume capacity (i.e., size) of the container being formed. Preferably, the aforesaid radius of curvature is at least 10% of the height of the inner sidewall, i.e., dimension D2 of the beaker to allow adequate thermoplastic flow and sidewall thickness. Thus, smaller beakers (e.g., beakers smaller than 200 ml liquid capacity, such as 50 and/or 100 ml beakers) will usually have a smaller radius of curvature (e.g., about 0.5 to 0.8 cm), intermediate size beakers (e.g., beakers of 250 ml to 1 L capacity) having intermediate radius of curvature (e.g., about 0.8 to 1.7 cm), and larger size beakers (e.g., about 1.5 L to 5 L or more) having larger radius of curvature (e.g., about 0.9 to 3 cm, or even larger).

The stability provided by the support contact area of and the outer sidewall advantageously enables additional design variations in the inner sidewall, transition zone, and/or bottom wall. Thus, for example, the radius of curvature of the transition zone portion of the sidewall can be of any length, up to the radius of the reservoir immediately above the transition zone. At the point where the radius of curvature is equal to the radius of the reservoir immediately above the transition zone, the bottom wall reaches the limit of being a single point. At lesser radii of curvature, the bottom wall generally will be substantially flat or will have an upward concave radius of curvature greater than the radius of curvature of the transition zone of the inner sidewall. (The bottom wall can even have upward convex curvature or an upward pointing generally conical shape, but these shapes are not currently expected to be advantageous.) Still further the inner sidewall can be inwardly curved over the entire vertical length of the sidewall, e.g., forming a hemisphere or other continuously curved shape). Likewise, all or part of the sidewall may be substantially conical. For example, the upper portion of the inner sidewall may be near vertical, while the lower portion is substantially conical. Usually there will be a curved transition zone between a near vertical inner sidewall section and a substantially conical section. In certain cases, the lower section of the sidewall will be curved or angled inward to a small, substantially flat bottom wall. Such configurations can, for example, provide the advantage of draining to a small bottom wall area while also providing a substantially flat bottom wall area for use of a magnetic stirring bar. While the designs having small flat area or curved bottom walls are readily produced and used, such designs are not practical for traditional beaker designs without external stabilization, stabilization which is provided in the present designs by the outer sidewall and its support contact area.

Still further variations can also be constructed in the present invention. For example, the wall of the reservoir (i.e., at least the inner surface of the inner sidewall can be given a wavy, fluted, or corrugated shape (usually oriented generally in the top to bottom direction of the reservoir). Such shape can provide a surface which enhances mixing when the reservoir contents are stirred, e.g., by increasing turbulence. Waves, corrugations, rounded pleats, and the like can likewise be formed in the outer sidewall (separately or in conjunction with similar shaping of the inner sidewall), e.g, thereby increasing the resistance to mechanical bending of the outer sidewall. Likewise, even though not presently preferred, reservoir and/or outer sidewalls may be formed which differ significantly from circular in horizontal cross-section, e.g, in oval or ovoid shapes. In yet further designs the inner sidewall can be generally stepped, such that the upper portion of the reservoir is substantially larger in diameter (or average diameter) than the lower portion. In this design, the smaller diameter lower portion allows more accurate reading of liquid volumes, while the upper portion provides substantial liquid capacity.

The variations described as well as numerous others are enabled by the present double sidewall design and are within this invention.

### Molding Method

As described above, the present double walled configuration for a thermoplastic laboratory beaker is quite different from a traditional beaker that is typically fabricated from glass or thermoplastic resin essentially in the form of an open cylinder with a closed bottom. While this double-walled beaker can be formed in a number of different ways (e.g., injection molding or thermoform molding), the preferred manufacturing method for commercial production of the present beaker uses the thermoforming process enabling cost-effective fabrication of the beaker. Both the cost of thermoform tooling for manufacturing the thermoplastic beaker and the cost and quantity of resin used in making each beaker is less than that required for injection molding a thermoplastic beaker of similar liquid capacity. Furthermore, the production speed for running a thermoformed plastic part is considerably greater than for an injection-molded part. All of these factors work to the advantage of the presently described beakers.

The accompanying paragraph is provided as a general description of the thermoforming process and has been derived from a Wikipedia article on the Worldwide Web, URL <http://en.wikipedia.org/wiki/Injection_molding>. Thermoforming is a manufacturing process where a plastic sheet is heated to a pliable forming temperature, formed to a specific shape in a mold, and trimmed to create a usable product. The sheet, or “film” when referring to thinner gauges and certain material types, is heated in an oven to a high enough temperature that it can be stretched into or onto a mold and cooled to a finished shape. In its simplest form, a small tabletop or lab size machine can be used to heat small cut sections of plastic sheet and stretch them over a mold using vacuum. This method is often used for sample and prototype parts. In complex and high-volume applications, very large production machines are utilized to heat and form the plastic sheet and trim the formed parts from the sheet in a continuous high-speed process, and can produce many thousands of finished parts per hour depending on the machine and mold size and the size of the parts being formed.

Thermoforming differs from injection molding, blow molding, rotational molding and other forms of processing plastics. Thin-gauge thermoforming is primarily for the manufacture of disposable cups, containers, lids, trays, blisters, clamshells, and other products for the food, medical, and general retail industries. Thick-gauge thermoforming includes parts as diverse as vehicle door and dash panels, refrigerator liners, utility vehicle beds, and plastic pallets.

### Configuration of Beaker Reduces Tipping and Spilling.

As indicated above, an advantageous feature of the present beakers is the greater footprint as compared to the footprint of conventional beakers. The larger footprint, providing stability against tipping, is especially notable for the beaker configured with a supporting flange as shown in FIG. 1. As shown, the beaker has a double walled structure and the supporting flange provides a substantially larger footprint than a conventional beaker. For example, the diameter of the bottom wall of a conventional 100 ml beaker measures approximately 5 cm (approximately 2.0 in.) whereas the diameter of the thermoformed supporting flange of the 100 ml beaker shown in FIG. 1 is approximately 8.25 cm (3.25 in.). Similarly, the diameter of the bottom wall of a conventional 250 ml beaker measures approximately 6.3 cm (2.5 in), whereas the diameter of the thermoformed supporting flange of the 250 ml beaker shown in FIG. 2 is over 10 cm (4.0 inches). Thus, the footprint/area of both of these thermoformed beakers is approximately 2.6 fold greater than the respective conventional beakers, thereby significantly stabilizing the thermoformed beakers against accidental tipping and spilling of liquids held in the lightweight beaker.

In addition to stabilization against spilling, the large footprint of the double-walled thermoformed beaker provides a number of other related benefits. A relatively heavy glass pipette can be rested upright in a thermoformed plastic beaker (thereby allowing re-use of the clean pipette) without the beaker tipping over. By contrast, conventional 100 ml and 250 ml plastic beakers even containing a moderate amount of liquid (e.g., 50-75 g) are still easily tipped and spilled if a 10 ml glass pipette is rested upright against the inside wall surface of these beakers.

### Description of Drawing Examples

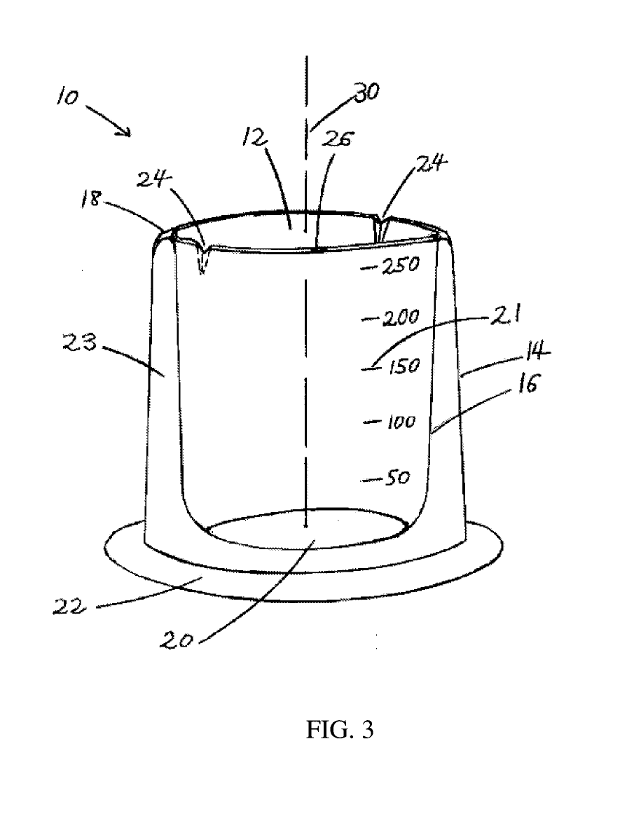

Referring to the Figures, beaker 10 is a double-walled beaker fabricated from a thermoplastic resin. In FIG. 1 it is approximately 6-8 cm wide and 6 cm tall holding approximately 100 ml liquid. In FIGS. 2 and 3 it is approximately 8-10 cm wide and 9 cm tall holding approximately 250 milliliters of liquid. Beaker 10 is typically thermoform-molded from virgin polyester e.g., PET, or may be thermoform- or injection-molded from polypropylene or polyethylene resin, for example. A liquid-holding reservoir portion, or simply “reservoir”, 12 of the beaker 10 is designed to hold liquids and is waterproof and resists most common organic solvents and caustic agents. When beaker 10 is fabricated using the thermoform process, generally a sheet of plastic such as 20-40 mil thick PET or polyester is heated, vacuum-shaped in a thermoforming mold, cooled, and its outer perimeter may be trimmed to size. The beaker is preferably fabricated with a double sidewall structure that includes a first outer sidewall 14, or simply “outer sidewall”, and a second inner sidewall 16, or simply “inner sidewall.” These two sidewalls meet and are connected (typically seamlessly, i.e., they are physically continuous at their upper limit height (uppermost edge)) to form the lip surface or lip edge 18 of beaker 10. Below the lip surface 18, the two sidewalls separate and diverge, usually at an angle of approximately 3 to 6 degrees, creating an air space between the sidewalls.

In the illustrated design, the inner sidewall 16 extends more or less vertically downward from the lip 18 of the beaker (usually with a slight inward angle or taper to provide proper mold release) a distance D1, and together with the adjoining bottom wall 20 of the beaker, form and define the reservoir portion 12 of the beaker. More specifically, the lower portion of the inner sidewall 16 is bent horizontally inward during thermoforming to form the bottom wall 20 of the liquid-holding reservoir portion of the beaker. As described above, instead of being flat, the bottom wall can be continuously curved and/or at least part of the sidewall wall may be curved or angled inward. In many embodiments, the bottom wall 20 orthogonally intersects the central vertical axis 30 of the beaker, but usually with a curved transition region. The distance from the lip 18 to the lowest portion of the bottom wall is D2. D2 is equal to or less than D1, so that the difference between D1 and D2 is the height of the air gap between the bottom wall and a support surface on which the beaker rests.

Volumetric graduation markings 21 are usually molded into or printed on the surface of the inner sidewall 16 of the beaker reservoir 12. Viewed in vertical cross-section in FIGS. 1 and 2, the beaker profile generally resembles the letter M in which the center portion of the M is thermoformed and stretched into a U-shaped reservoir 12 for holding liquid.

In summary, this U-shaped reservoir 12 is composed of the inner sidewall portion 16 and the bottom wall portion 20 of the beaker. The outer sidewall portion 14 of the beaker corresponds to the outer upright elements of the letter M. To add physical rigidity and stabilize the beaker 10 against accidental tipping and spilling of liquids, the lower portion of the outer sidewall 14 of the beaker is preferably bent outward around the beaker, i.e., thermoformed horizontally outward, to form a planar supporting flange 22 (aka “supporting foot”) around the circumference of the beaker as shown in FIG. 3.

The location of the outward bend in the beaker's outer sidewall 14 to produce the supporting flange 22 is preferably set slightly below (e.g., 1-10 mm below) the height of the bottom wall 20 of the beaker so that the beaker rests on its supporting flange 22 rather than on the beaker's bottom wall 20 when placed on a flat working surface such as a laboratory bench. Therefore, an air space 23 is formed between the outer and inner sidewalls (14 and 16), and also beneath the bottom wall of the beaker so that trapped air can provide beneficial thermal insulation around the sides and bottom of the liquid-holding reservoir 12 of beaker 10. While a conventional single walled beaker is very susceptible to changing external temperature, the insulating airspace described above, helps maintain a more constant liquid temperature when either a hot or cold liquid is placed in the presently configured beaker. Similarly, when holding or carrying a beaker of the present design in ones hand, the double sidewall structure of the beaker helps prevent a substantial change in the temperature of a liquid in the beaker. The double sidewall also helps prevent hand injury from a very cold or hot liquid in the beaker.

Furthermore, the outer sidewall 14, together with the supporting flange 22 function to enlarged the footprint of the beaker, thereby providing greater stability against accidental tipping and spilling of liquid contained in the beaker's reservoir 12. Preferably, milliliter volumetric graduation markings 22 (molded into the plastic or printed) are included on the inner sidewall 16 of the beaker to facilitate estimation of liquid volumes held within the beaker's reservoir portion 12. In addition, it is useful to include at least one, and preferably two V or U-shaped grooves 24 in beaker lip 18 which: (a) facilitate pouring of liquid from the beaker and (b) provide resting grooves for resting a liquid transfer pipette across top of the beaker if a laboratory worker wishes to temporarily set down a pipette across the lip of the beaker.

In embodiments in which the bottom wall is curved or the inner sidewall tapers to a small bottom wall area surface, the beaker could not stably rest on the bottom wall without additional stabilization, making the outer sidewall (preferably with supporting flange) particularly advantageous.

In addition, it may be useful to introduce at least one small ventilation opening 26, i.e., a penetrating hole (approximately 1 to 3 mm in diameter) in the beaker lip surface 18 using a punch or hot pin die. This ventilation opening 26 can be conveniently made after the vacuum thermoforming step when, for example, the formed part is being trimmed. The opening is preferably positioned some distance from the groove(s) 24 in the beaker lip 18 so as to not interfere with pouring of liquids from the beaker. A function of the ventilation opening is to allow escape of trapped air from the air space 23 separating the beaker sidewalls, e.g., if and when the laboratory worker wishes to incubate the beaker in a water bath. That is, to eliminate the beaker's natural buoyancy upon partial submersion of the beaker in an incubating water bath, trapped air must be allowed to escape. Thus, the ventilation opening 26 allows air to escape and incubator bath water to rise into the airspace 23 between the outer and inner sidewalls (14 and 16) and generally around the reservoir 12 so as to achieve rapid thermal equilibration of a liquid in the beaker. In addition, such ventilation opening prevents the flange from forming a tight seal against a support surface such as a laboratory bench top. Prevention such a tight seal from forming may also be accomplished with alternate structures which provide a small air passage between the air gap between the beaker sidewalls and the external air. For example, a small air passage may be provided as a small hole through the outer sidewall or a groove on the lower surface of the flange which traverses the entire width of the flange. Notwithstanding the presence of ventilation opening 26 or other alternative air passage to the air gap space, when the beaker is incubated in air, the airspace 23 still provides substantial thermal stability, i.e., insulation, around the beaker's reservoir 12.

### DEFINITIONS

As used in this description and the accompanying claims, the following terms shall have the meanings indicated, unless the context otherwise requires. Terms not defined shall have the meanings reasonably used in the context of normal laboratory practice.

The term “beaker” as used herein, is a simple container for stirring, mixing and heating liquids commonly used in many laboratories. Traditional beakers are generally cylindrical in shape, with a flat bottom and a lip for pouring. Many also have a small spout to aid in pouring. Beakers are available in a wide range of sizes, from approximately one milliliter up to several liters. So called “Standard” (aka, “low-form”) beakers typically have a height about 1.2-1.4 times the diameter. The common low form beaker with a spout has been called the Griffin form. These are used for a wide variety of laboratory procedures—from preparing solutions and decanting supernatant fluids to carrying out simple reactions. “Tall form” beakers have a height about twice the diameter. These are sometimes called Berzelius beakers, and are mostly used for titration. “Crystallizer” beakers are short and squat because they may be used to perform crystallization. They are also used as incubation vessels. A beaker is distinguished from a laboratory flask, such as an Erlenmeyer or Florence flask, by having sides that are essentially straight rather than sloping. The exception to this definition is a slightly conical sided beaker called a Phillips beaker.

Traditional beakers are commonly made of glass (usually borosilicate glass) but can also be in metal such as stainless steel or aluminum, or certain plastics as described above. Beakers are often graduated, i.e., marked on the side with lines indicating the volume contained. For instance, a 250 ml beaker may be marked with lines to estimate the volume of liquid contained, e.g., 50, 100, 150, 200, and 250 ml of volume. While the presence of a lip on the uppermost edge of a beaker prevents use of a conventional sealing cover, a beaker may be covered by a watch glass, aluminum foil, or plastic wrap to prevent contamination or loss of the contents, while allowing venting via the spout. Beakers are typically transparent or translucent for visualizing a liquid held within. Occasionally, for storage of photosensitive liquids, the container may be amber-colored or opaque.

The terms “first outer sidewall” (aka “outer sidewall”) and the “second inner sidewall” (aka “inner sidewall”) as used herein refer to the two sidewall components of the beaker which are joined at the lip of the beaker. Usually the junction between the inner and outer sidewalls is continuous and seamless. Also, in most cases, the outer sidewall is generally cylindrical. Usually the inner sidewall is also generally cylindrical, but as described herein may also be constructed with a variety of different shapes which are releasable from the mold. In many cases, the inner and outer sidewalls are substantially concentric; that is, a horizontal cross-section through the reservoir section above the bottom wall will reveal two substantially concentric rings. The inner and outer sidewalls are spaced apart and slope away from one another below the lip. For cases in which the inner and outer sidewalls are both generally cylindrical, the sidewalls usually diverge with an angle of divergence commonly approximately three to six degrees. The lower portion of the outer sidewall forms an area which contacts the support surface. For example, the outer sidewall may vertically terminate where it meets the lab bench to support the beaker structure, or advantageously the outer sidewall may be bent and thermoformed outward away from the center vertical axis of the beaker to form a narrow horizontal “supporting flange” (aka, “support foot”) that supports the beaker structure. This flange may, for example, be in the range of about one millimeter to two centimeters.

The “center axis” or “vertical axis” of the beaker is the axis traveling vertically in and out of the beaker along the centerline of the container with the beaker resting on its surface contact area upon a horizontal, planar surface.

The term “substantially planar” as used herein, means that the supporting flange surface upon which the beaker rests is sufficiently flat (or possesses sufficient areas that lie in the same plane) so that the container is stable and exhibits little if any rocking when the container is placed on a flat, horizontal surface.

The term “adjoining sidewall” as used herein refers to a wall such as the inner sidewall described herein, juxtaposed or nearly juxtaposed (for example, it could be separated by a rounded corner) to the bottom wall of the beaker.

As used herein in connection with the present beakers, “beaker capacity”, “volume capacity”, and similar terms refer to the liquid volume which can practically be held within the body of the beaker that does not cause or create high risk of overflow at the beaker's lip, not to the maximal volume of liquid which can be placed in the beaker. Depending upon the size of the thermoformed beaker, volume capacity of the presently described beakers is usually between 10 ml and 5 liters. This range of volumes is meant to span the range of common beaker sizes found in laboratories.

As used in connection with the present beakers, the terms “aspect ratio” and “form factor” are equivalent and refer to the ratio of beaker reservoir depth to reservoir diameter. The reservoir diameter is measured immediately below the lip surface where the curvature of the lip surface ends and, for substantially cylindrical inner sidewalls, the essentially straight portion of the inner sidewall begins. The depth is measured as the shortest distance from the horizontal plane intersecting the uppermost part of the upper surface to the horizontal plane intersecting the lowest point of the inner surface of the bottom wall.

In the context of the present invention, use of the terms “about” and “approximately” in connection with a linear or volume measurement means within a range of 0.8 to 1.2 times the specified value, unless clearly indicated to the contrary. Use of the terms “about” and “approximately” expressly include narrower limits, for example, within a range of 0.9 to 1.1 times, 0.95 to 1.05 times, 0.97 to 1.03 times, 0.98 to 1.02, and 0.99 to 1.01 times the specified value.

As used in connection with the present invention, the term “radius of curvature” refers to the radius of a circle which matches the specified material arc (for sections of a circle) or, in the case of a non-circular curve section, the radius of a circle which intersects the endpoints of the curve section and minimizes the area between the circular curve section and the specified material curve section.

The term “substantially” is used herein to mean that the indicated characteristic is present but some deviation is allowed. The amount of allowable deviation can vary depending on the particular context. Despite the deviation, persons familiar with laboratory practice will recognize the indicated characteristic as present. Thus, for example, “substantially concentric” indicates two spaced-apart rings are roughly the same distance apart along their entire circumferences. Similarly, “substantially horizontal” indicates a surface or plane or the like is close to being exactly horizontal, but small deviations are included, e.g., either an overall or local deviation of ½ or ¼ degree.

When used in reference to the present beakers, terms of orientation and/or extent, such as horizontal, upper, lower, top, and bottom have their conventional meanings as defined by reference to the orientation of a beaker resting normally on its support surface contact area upon a flat, horizontal support surface.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, those skilled in the art will recognize that the invention may suitably be practiced using any of a variety of sources of material, e.g., diverse thermoplastics to fabricate the beaker, and any one of a variety of beaker body shapes, sizes and contours, besides a low form or standard beaker holding 100 or 250 ml of liquid in its reservoir portion.

The invention illustratively described herein suitably may be practiced in the absence of any element or elements, limitation or limitations which is not specifically disclosed herein. Thus, for example, in each instance herein any of the terms “comprising,” “consisting essentially of” and “consisting of” may be replaced with either of the other two terms. The terms and expressions which have been employed are used as terms of description and not of limitation, and there is not intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group. For example, if there are alternatives A, B, and C, all of the following possibilities are included: A separately, B separately, C separately, A and B, A and C, B and C, and A and B and C. Thus, the embodiments expressly include any subset or subgroup of those alternatives, for example, any subset of the types of plastic materials used to fabricate the beaker. While each such subset or subgroup could be listed separately, for the sake of brevity, such a listing is replaced by the present description.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

While certain embodiments and examples have been used to describe the present invention, many variations are possible and are within the spirit and scope of the invention. Such variations will be apparent to those skilled in the art upon inspection of the specification and claims herein. Other embodiments are within the following claims.

1-24. (canceled)

25. A method for making a double-walled beaker, comprising
thermoforming a heated thermoplastic sheet on a thermoform mold configured such that said sheet is formed into an open-topped beaker which comprises
an outer upright sidewall, an inner sidewall, and a bottom wall which together form an open-topped container,
wherein said outer sidewall and inner sidewall are united at their upper limit forming a lip surface and diverge from each other below said lip surface creating an air space between said sidewalls, said outer sidewall extending downward a first distance D1 below said lip surface to a support contact area formed at the lower limit of said outer sidewall and said inner sidewall extends downward a second distance D2 from said lip surface and then bends inward joining with a bottom wall together forming said reservoir portion, D2 being equal to or less than D1.
